(19) United States
(12) Patent Application Publication
(10) Pub. No.: US 2006/0061941 A1
(43) Pub. Date: Mar. 23, 2006

(54) Electric component provided with a cable, especially for use in a vehicle

(76) Inventor: Wolfgang Uwe Spies, Haan (DE)

Correspondence Address: Friedrich Kueffner, Suite 910, 317 Madison Avenue, New York, NY, 10017, US

(21) Appl. No.: 11/194,099

(22) Filed: Jul. 29, 2005

(30) Foreign Application Priority Data
Jul. 31, 2004 (DE) 10 2004 037 243.8

(51) Int. Cl. H02B 1/00

(52) U.S. Cl. 361/600

(57) ABSTRACT

An electric component secured on a support has an electric cable having a first end fixedly connected to the electric component and a second end connectable to a remote connecting point of a vehicle. The cable has a fixed total length. A first cable section adjoins the fixed cable end and is arranged as a loop having a changeable loop length. A clamp is provided on the support or the electric component for securing the loop end. The cable has a second cable section as an effective cable length that adjoins the loop end and extends downstream of the clamp to the connecting point. The effective cable length is adjustable by changing the length of the loop upstream of the clamp.

### BACKGROUND OF THE INVENTION

1. Field of the Invention

The invention relates to an electric component, especially for vehicles, wherein the electric component is supported on a support and comprises an electric cable having a first cable end that is fixedly connected to the electric component. The second cable end is to be coupled or connected as needed to a remote connecting point provided within the vehicle. Certain functions within the vehicle can be performed by means of the electric component.

2. Description of the Related Art

One type of use resides in that the electric component is connected to an actuator, for example, for actuating a handle for opening a rear door of a vehicle (WO 03/062569 A1). The electric component in this case is a switch arranged in the housing of the actuator and connected via cable to an electric control of the lock.

There are many types of uses of such electric components, for example, in vehicles of different type. As a function of the application situation, the cable must have a different length for spanning the distance between the electric component and the connecting location for the cable. It is therefore necessary to manufacture, stock and mount electric components having appropriate different cable lengths. Another possibility resides in that intermediated pieces with adapters are connected between the connecting end of the cable and the electric connecting point in the vehicle when a provided cable length must be extended. This is cost-intensive and cumbersome. On the other hand, it is not convenient to employ an electric component having a cable length that is much too long for bridging a small spacing to the connecting location because the loose cable piece must be installed and takes up space. A loose cable piece must not be present in the vehicle for safety reasons.

### SUMMARY OF THE INVENTION

It is an object of the present invention to develop an inexpensive electric component of the aforementioned kind that is universally useable and can be adjusted easily to different spatial conditions.

In accordance with the present invention, this is achieved in that the cable section adjoining the fixed cable end is arranged to form a loop having a changeable loop length, wherein on the support and/or on the electric component a clamp is provided that receives the loop end in a through opening, wherein an effective cable length adjoining the loop extends to the connecting point, and wherein the cable, even though it has a fixed total length, has an effective length downstream of the clamp that is adjustable by changing the length of the loop upstream of the clamp.

The cable is produced with a fixed total length that matches a length to be spanned to the connecting point that is farthest away from the support. In this way, the electric component can be used in all other situations where this distance is smaller. The excess length is placed in the form of a loop and the loop end is received in a clamp that is arranged on the support or the housing of the electric component. In this way, the support and the cable loop form a compact module that can always be mounted in a space-saving way in the vehicle. Downstream of the received loop end, a cable section having the required or proper length (effective length) is positioned. The effective length, according to the invention, can be adjusted as a function of the situation of use by reducing the length of the loop upstream of the clamp. In this way, it is possible to produce large numbers of the electric components already provided with the cable. The electric components can be adjusted easily and quickly to the situation of use. This is so because the cable is arranged within the clamp such that it can be pulled through the through opening but is self-locking within the thrcugh opening of the clamp. Large production numbers enable an inexpensive manufacture of the electric component according to the invention.

In the following, features and advantages of the invention will be explained in connection with the drawings illustrating several embodiments, in particular as an electric component integrated into an actuator.

### BRIEF DESCRIPTION OF THE DRAWING

In the drawing:

FIG. 1 is a perspective view of a first embodiment of an actuator according to the invention before mounting in the vehicle, the view showing the rear of the housing;

FIG. 2 is an illustration analog to the illustration of FIG. 1 of a second type of use of the same actuator;

FIG. 3 shows a detail rear view of a cover of an electric component before being mounted in the actuator according to the invention shown in FIGS. 1 and 2;

FIG. 4 is a cross-section of a detail of the actuator of FIG. 1 along the stepped section line IV-IV;

FIG. 5 shows also a detail in longitudinal section along stepped section line V-V of the cover of the electric component illustrated in FIG. 4, wherein a top part of the cover has been removed to improve clarity of the illustration;

FIG. 6 is an illustration corresponding to FIG. 4 of a second embodiment of the actuator;

FIG. 7a shows in a schematic illustration analog to FIG. 4 a portion of a third embodiment of the actuator according to the invention before being mounted on the housing;

FIG. 7b shows the electric component illustrated in FIG. 7a after having been mounted in the actuator of which only a portion is shown;

FIG. 8 is a fourth embodiment similar to the embodiment of FIG. 7a; and

FIG. 9 shows in analogy to the illustration of FIG. 7b a fifth embodiment of the actuator according to the invention, wherein only a section in the area of the mounted electric component is shown.

### DESCRIPTION OF THE PREFERRED EMBODIMENTS

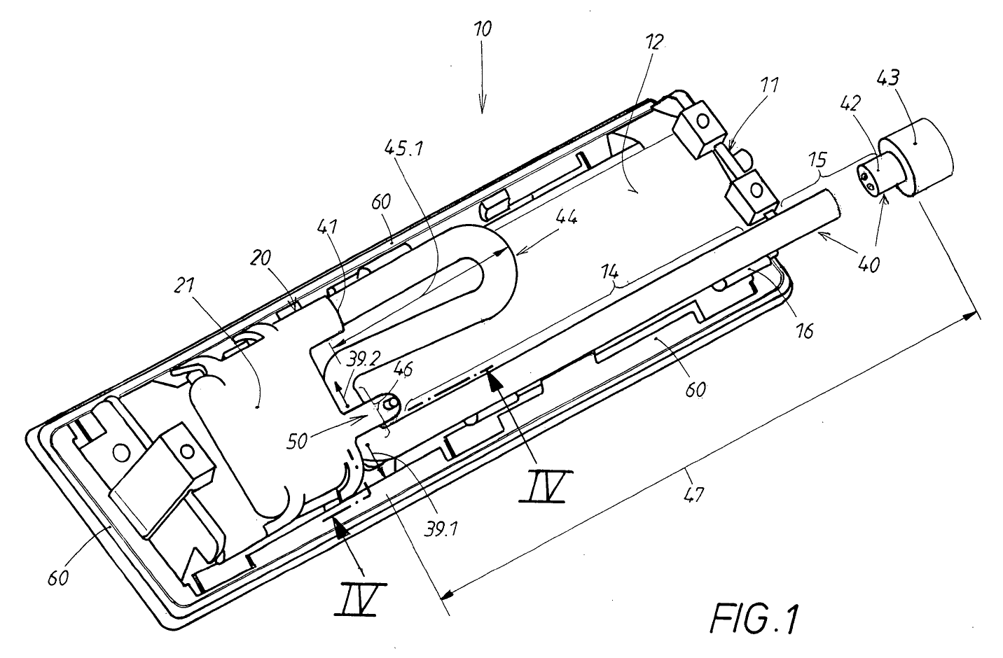

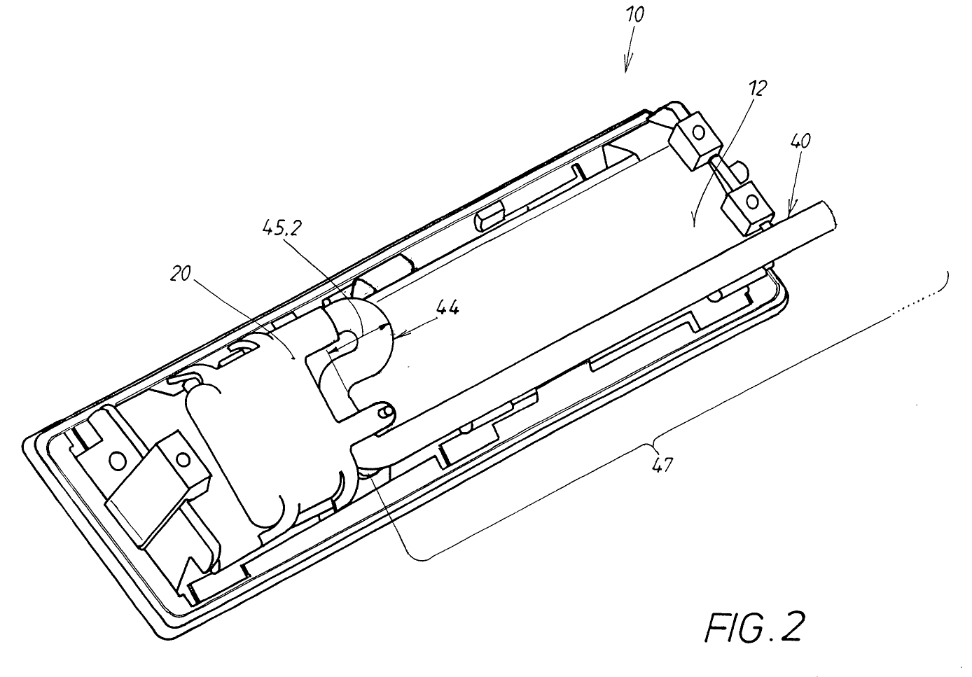

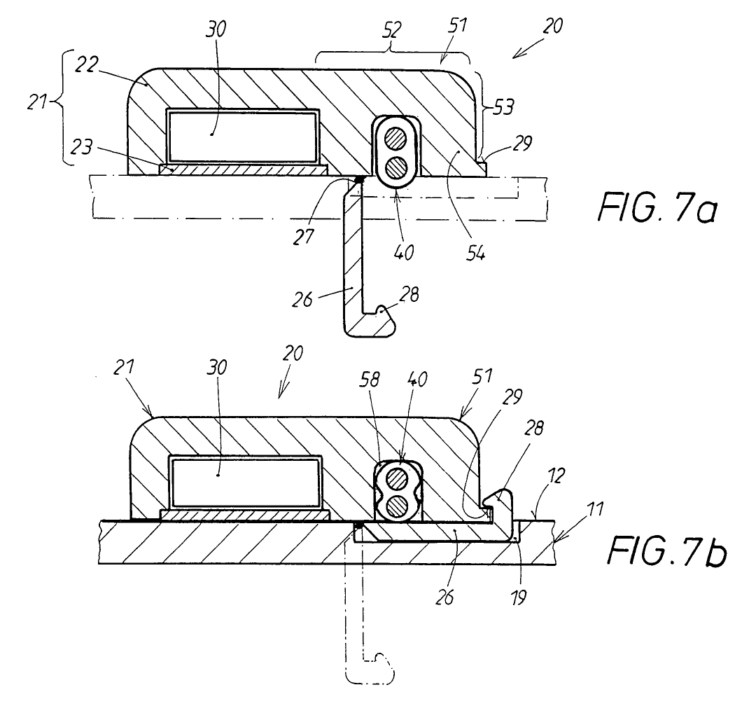

As already mentioned, the actuator 10 according to the invention illustrated in the drawings is provided for the lock of the rear door of a vehicle. The views show the rear outer surface 12 of a support that is designed as a housing 11. The housing 11 is shell-shaped. In the interior of the shell, a door handle, not illustrated in detail, is supported that cooperates with an electric component 20 arranged on the outer side 11 of the housing when actuated. FIGS. 1 and 2 only show the rear of the cover 21 of this component 20. The cover 21 encloses a switch 30 that is illustrated in detail in FIG. 3 and only schematically in FIGS. 7a, 7b; the switch 30 comprises an actuator pin 31 illustrated in FIG. 3 that upon actuation of the handle controls the different switch positions in the interior of the switch 30. The opening of the shell-shaped housing 11, not illustrated in the drawings, is covered by an elastic diaphragm. The diaphragm engages elastically the edge area of the shell-shaped housing like a frame at the locations illustrated at 60 in FIG. 1; in this way, it covers together with the handle the interior of the shell of the housing 11.

The electric component 20 is connected to an electric cable 40. The cable 40 is connected with a first end 41 fixedly to the contacts in the electric component 20 so that this end is referred to as “fixed end”. The other end 42 of the cable is connected to a remote connecting location in the vehicle and is therefore referred to as “connecting end”. In the present case, the connecting end 42 is an electric coupling 43 that interacts with an electric counter coupling providing the connecting point at the vehicle, the electric counter coupling not illustrated in detail.

According to the invention, the cable section adjoining the fixed end 41 is arranged in a loop 44 whose loop length, as illustrated in FIG. 1 at 45.1 and in FIG. 2 at 45.2, is changeable. On the housing 11, a clamp 50 is provided that holds the loop end 46 in a self-locking way in its through opening but allows the loop to be pulled through. The loop 44 extends on the rear outer surface 12 of the housing 11. The received loop end 46 is adjoined by an effective length 47 of the cable 40 extending outside of the housing. Accordingly, the effective length 47 of the cable 40 can be matched to the required distance between the actuator 10 and the connecting location in the vehicle. Despite different requirements in practice, an actuator 10 in accordance with the present invention can be provided with a precisely matched effective length 47 of the cable 40 in that the cable 40 is pulled out at the clamp 50 by reducing the length of the loop in the direction of arrow 39.1 (reduced loop length shown in FIG. 2) or by extending the loop length by pushing the cable back in the direction of arrow 39.2 (FIG. 1).

As can be seen best in FIG. 3, the cover 21 of the electric component 20 is of a two-part configuration comprised of a cap-shaped top part 22 having a cap opening that is covered partially by a plate-shaped bottom part 23. The plate-shaped bottom part 23 has a cutout through which the actuator pin 31 of the switch 10 is accessible. The cover 21, in the present case the top part 22, has two opposed clips 24 that enable a plug-in mounting of the electric component 20 on the housing 11. For this purpose, the housing 11 has noses at the edge behind which the clips 24 snap into place when the electric component 20 is inserted. The cover 20 is provided with an inlet 59 shown best in FIG. 3 for the fixed end 41 of the cable 40.

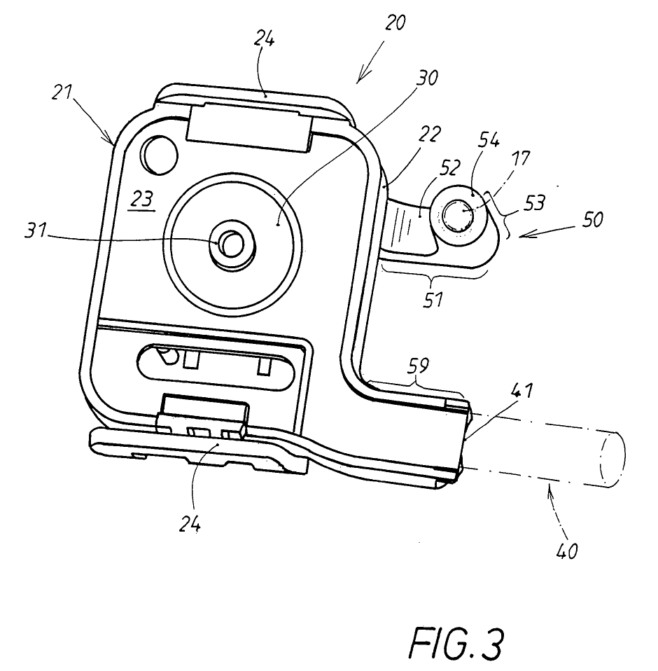

In the first embodiment according to FIG. 1 through 4, a part 51 of the clamp 50 is formed as a unitary part of the cover 21 in the form of an L-shaped bracket. As illustrated best in FIG. 4, the L-shaped bracket 51 can be divided into an upper leg 52 formed on the top part 22 of the cover and an angled lateral leg 53. The free end 54 of the lateral leg 53 is oriented toward the outer surface 12 of the housing 11.

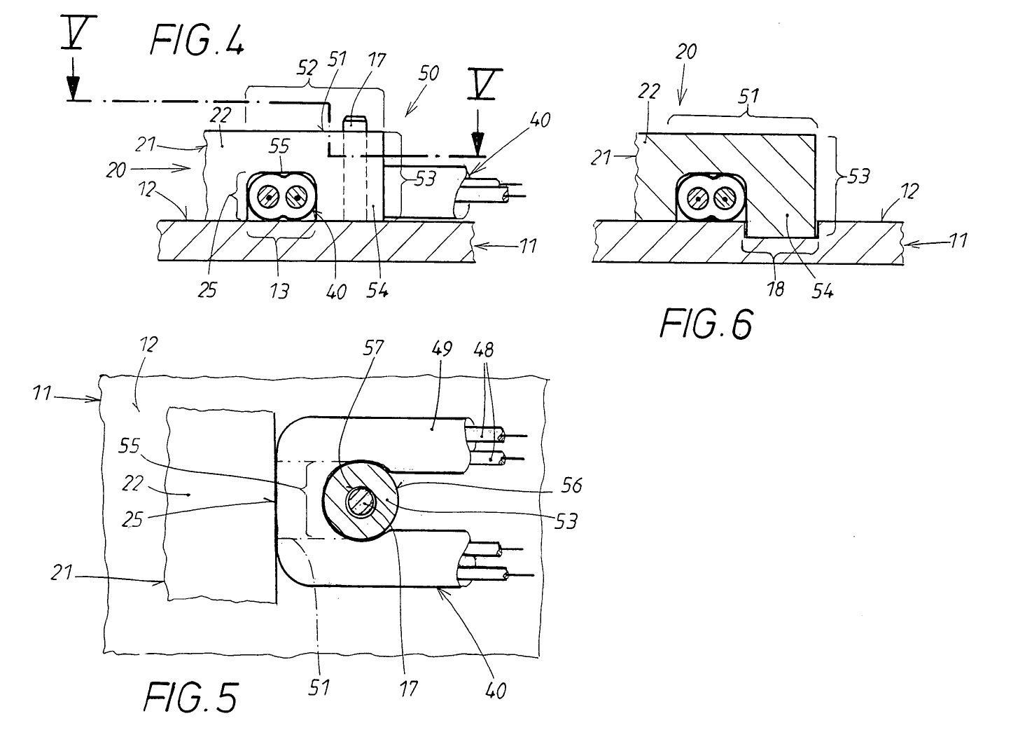

The surface area 13 of the outer housing surface 12 that is spanned by the bracket 51 also contributes to forming the clamp 50. On the other hand, the sidewall 25 of the top part 22 of the cover positioned underneath the bracket 51 also provides a portion of the clamp 51. A passage 55 for the cable 40 is provided by the bracket 51 and the aforementioned surfaces 13, 25; the cross-section of the cable 40 can be radially and axially deformed in the clamping area 51 as shown in FIGS. 4 and 5. The cover 21, in particular the top part 22, is comprised of elastomeric material that in the area of the passage 55 increases friction and, in this way, impedes pulling of the cable in the direction of arrows 39.1 and 39.2 even more. An accidental pulling or pushing of the cable in or out of the clamp 51 is therefore excluded.

This cross-sectional deformation is favored because the cable 40, as shown in FIG. 5, is comprised of two electrically insulated lines 48 and a hose 49 loosely enclosing or enveloping them. The cable 40 is deflected downstream of the passage 55. An S-shaped course of the cable 40 is provided by the U-shaped course of the loop shown in FIG. 1 upstream of the passage 55 and also by the initial piece 14 of the effective length 47 of the cable 40 because the piece 14 still extends along the outer surface 12 of the housing. This initial piece 14 is determined by a guide element 16 provided on the housing 11; the actual extension piece 15 of the cable 40 adjoins it.

The lateral leg 53 of the bracket 51, as illustrated in FIG. 3 and primarily in FIG. 5, has a round profile 56. This is beneficial in regard to the deflection of the cable 40. At the location where the free end 54 of the bracket 51 meets the housing, an anchoring action relative to the outer housing surface 12 should be provided. It is designed in the first embodiment of FIGS. 1 through 4 in that on the housing 11 a projection in the form of a projecting pin 17 is provided while a recess in the form of an axial bore 57 is provided in the lateral leg 53. The pin 17 moves into the bore 57 when the electric component 20 is placed onto the housing 11 in the way described in connection with FIG. 3 and is locked thereat by the clips 24.

As already mentioned, FIG. 6 shows an alternative anchoring action of the free end 54 of the lateral leg 53 on the housing 11. In this case, on the outer surface 12 of the housing 11, a recess 18 is provided into which the extended free end 54 penetrates after mounting of the cover.

A third embodiment is illustrated in FIGS. 7a, 7b. Analog components are identified by same reference numerals as in the embodiment of FIGS. 1 through 4; the above description in regard to same parts therefore also applies to this embodiment. It is therefore sufficient to discuss only the differences. In this third embodiment, the top part 22 of the cover of the electric component 28 is provided with a unitary tab 26. The tab 26 is connected by a film hinge 27 to the cover 21 and, as illustrated in FIG. 7b, can be folded against the lateral leg 53 of the bracket 51 embodied as an L-shaped member. In the folded state, the tab 26 is anchored on the lateral leg 53.

In the third embodiment of FIGS. 7a, 7b, the anchoring action is provided, on the one hand, by a hook 28 on the free end of the tab 26. As a counter element to the hook 28, the free end 54 of the L-shaped leg 53 is provided with a shoulder 29. The shoulder 29 is generated by a step at the end face. In the folded-down position of the tab 26 according to FIG. 7a, the cable 40 can be inserted into the interior of the bracket 51. Subsequently, the tab 26 is folded upwardly and engages with its hook 28 the shoulder 29 provided on the L-shaped bracket 51; this is illustrated in FIG. 7b. As shown in FIG. 7b, a special passage 58 for the cable 40 is provided in this way. The cable 40 is surrounded and deformed on all sides by the elastomer material of the cover, the bracket 51, and the tab 26. In this embodiment, it is however also recommended to provide on the outer surface 12 of the housing 11 a corresponding profiled recess 19 in which, as shown in FIG. 7, after mounting of the electric component 28 in the housing 11, the tab 26 can be sunk.

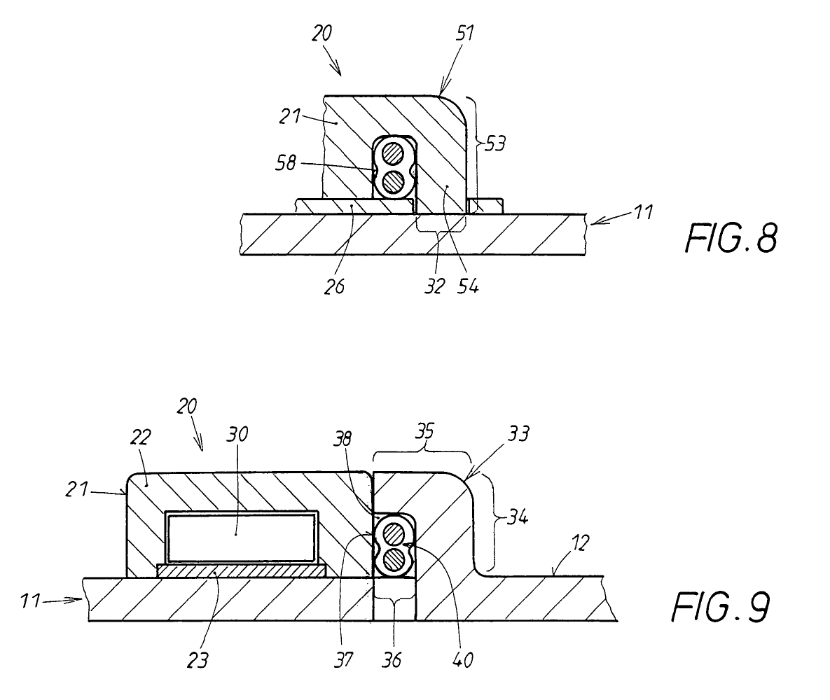

The fourth embodiment of FIG. 8 shows an alternative to the preceding third embodiment. An alternative configuration of the anchoring means of the free end 54 of the lateral leg of the L-shaped bracket 51 is provided. The passage 58 is also closed off by a tab 26. In this case, the tab 26 has a hole 32. After mounting of the cover, the free end 54 of the lateral leg 53 engages the hole 32.

In FIG. 9, a fifth embodiment is schematically illustrated. Inasmuch as the previous reference numerals are used, the same description applies. The most important difference is that an L-shaped bracket 33 is formed as a unitary part of the housing 11 and projects away from its outer surface 12. In this case, the components of this bracket 33 are also referred to as lateral leg (34) and top leg (35).

The lateral leg 34 of the bracket 33 is fixed on the housing 11 and has at its free end an angled top leg 35. The top leg 35 engages a surface area 36 on the outer side 12 of the housing where, because of manufacturing-technological reasons for injection molding the housing 11, a hole is arranged underneath the top leg 35. Between the free end of the top leg 35 and the surface area 36, the bracket opening is closed by a sidewall 37 of the cover 21 or its top part 22. In this way, a combined passage 38 for a positive and/or non-positive fixation of the cable 40 on the component 20 is provided after the component has been mounted in the way described above on the housing 11.

As already mentioned, the electric component according to the invention can be embodied independent of an actuator. For example, such a component could be in the form of a microswitch that is arranged behind the deformable wall of a car body. In this case, the deformation of the car body is used as an actuator. The electric component could also be seated on a support of an external door handle or a support housing of locks.

While specific embodiments of the invention have been shown and described in detail to illustrate the inventive principles, it will be understood that the invention may be embodied otherwise without departing from such principles.

What is claimed is:

1. An electric component arrangement comprising:
a support;
an electric component mounted on the support;
an electric cable having a first cable end that is fixedly connected to the electric component and a second cable end configured to be connected as needed to a remote connecting point provided within a vehicle, wherein the cable has a fixed total length;
the cable comprising a first cable section adjoining the fixed cable end and arranged to form a loop having a changeable loop length;
a clamp provided on at least one of the support and the electric component, wherein the clamp secures a loop end of the loop;
wherein the cable has a second cable section that adjoins the loop end and extends downstream of the clamp to the connecting point and forms an effective cable length; and
wherein the effective cable length is adjustable by changing the length of the loop upstream of the clamp.

2. The electric component arrangement according to claim 1, wherein the support is a housing and wherein the electric component is arranged inside or outside of the housing and serves as an actuator for locks of the vehicle.

3. The electric component arrangement according to claim 2, wherein the loop rests against an outer surface of the housing with at least a portion of the changeable loop length.

4. The electric component arrangement according to claim 1, wherein the clamp secures the cable by at least one of friction and positive engagement.

5. The electric component arrangement according to claim 1, wherein the cable is secured in the clamp such that the cable can be pulled through but is self-locking.

6. The electric component arrangement according to claim 1, wherein the electric component comprises a cover having an inlet for the first end of the cable, wherein the cover secures the electric component on an outer surface of the support, and wherein at least a portion of the clamp is formed as a unitary part of the cover.

7. The electric component arrangement according to claim 6, wherein the electric component is a switch and comprises a switch cover.

8. The electric component arrangement according to claim 6, wherein the cover is composed of elastomer material and the elastomer material increase friction between the clamp and the cable.

9. The electric component arrangement according to claim 6, comprising a bracket projecting from the cover or the support, wherein the bracket and a surface area of the cover or the support, respectively, across which surface area the bracket extends, provide a passage for the cable, wherein the passage is a through opening of the clamp.

10. The electric component arrangement according to claim 9, wherein the bracket is L-shaped and is comprised of a top leg connected to the cover and a lateral leg angled relative to the top leg, wherein a free end of the lateral leg is oriented toward the outer surface of the support.

11. The electric component arrangement according to claim 9, wherein the cable in the area of the passage has a cross-sectional contour that acts on the cable to impede pulling of the cable through the passage.

12. The electric component arrangement according to claim 9, wherein the loop upstream of the passage is U-shaped and wherein the cable is deflected downstream of the passage and supplements the U-shaped loop to an S-shape, wherein a portion of the effective length of the cable adjoining the clamp is guided along the outer surface of the support that is in the form of a housing and a remainder of the effective length exits the housing.

13. The electric component arrangement according to claim 10, wherein at least one of the lateral leg and the top leg has a round profile at least within the passage and the round profile is suitable for deflecting the cable.

14. The electric component arrangement according to claim 10, wherein the free end of the lateral leg is anchored by anchoring means in at least one of the support and the cover.

15. The electric component arrangement according to claim 14, wherein the anchoring means comprise a projection and a recess for receiving the projection, wherein the projection is provided on the lateral leg or the support and the recess is provided on the support or the lateral leg, respectively.

16. The electric component arrangement according to claim 15, wherein the projection is a pin projecting from the support and wherein the recess is a bore in the lateral leg into which bore the pin is inserted when mounting the cover.

17. The electric component arrangement according to claim 15, wherein the outer surface of the support has a recess into which the free end of the lateral leg of the bracket is inserted after mounting of the cover.

18. The electric component arrangement according to claim 10, wherein the cover has a tab interacting with the bracket provided on the cover, wherein the tab, when engaging the bracket, closes an opening of the bracket and an inner surface facing the bracket defines together with the bracket the passage.

19. The electric component arrangement according to claim 18, wherein the tab is connected by a film hinge to the cover and wherein the tab, when engaging the bracket, is folded against the lateral leg and is anchored on the lateral leg.

20. The electric component arrangement according to claim 19, wherein the outer surface of the support has a recess in which the tab is sunk when the cover is mounted.

21. The electric component arrangement according to claim 18, wherein the tab has a free end provided with a hook and wherein the lateral leg has a free end with a shoulder that is engaged by the hook when the cover is mounted.

22. The electric component arrangement according to claim 18, wherein the tab has a hole and wherein a free end of the lateral leg engages the hole when the cover is mounted.

23. The electric component arrangement according to claim 9, wherein the support is a housing and wherein the bracket is formed as a unitary part of the housing, wherein an opening of the bracket faces a sidewall of the cover mounted on the housing, and wherein the bracket and the sidewall of the cover define the passage for the cable.

24. The electric component arrangement according to claim 23, wherein the bracket is L-shaped and comprises a lateral leg fixed on the housing and an angled top leg, wherein the top leg spans a surface area of the housing extending between the lateral leg and the sidewall of the cover mounted on the housing.
